(19) United States
(12) Patent Application Publication
(10) Pub. No.: US 2013/0331993 A1
(43) Pub. Date: Dec. 12, 2013

(54) Ergonomic computer workstation to improve or maintain health

(71) Applicants: Richard Mark Detsch, West Lebanon, NH (US); Walter Joseph Moore, JR., West Canaan, NH (US); Elizabeth McPherson-Dain-Owens, Sant Fe, NM (US); Sarah Elysse Rocio, Menlo Park, CA (US); Emily Mason-Osann, Goram, ME (US)

(72) Inventors: Richard Mark Detsch, West Lebanon, NH (US); Walter Joseph Moore, JR., West Canaan, NH (US); Elizabeth McPherson-Dain-Owens, Sant Fe, NM (US); Sarah Elysse Rocio, Menlo Park, CA (US); Emily Mason-Osann, Goram, ME (US)

(21) Appl. No.: 13/507,177

(22) Filed: Jun. 11, 2012

(51) Int. Cl. G05B 15/02

(52) U.S. Cl. 700/275

(57) ABSTRACT

Workstation methods are described which assure that healthy human motions are undertaken while a user is performing tasks over an extended period, as is typical of working on a computer or assembling parts. The workstation includes powered components that are used to change the user's position with time. Biosensors are used to record the physiological state of the users as well as the duration, extent and intensity of user activity. Mechanical sensors are used to measure the position, strain, and acceleration of the workstation joints. Pressure grids are used to measure the contact forces between the user and the workstation. Remote sensors are used to determine user position, and to interpret user gestures. User profiles are maintained that include health history, injuries, fitness goals and physical limitations. A central processing unit uses sensor data and the user's profile to calculate healthy workstation motion routines.

### RELATED APPLICATION

This application claims benefit of and priority to U.S. Provisional Application No. 676/520,577 filed Jun. 13, 2011, the entirety of which is hereby incorporated herein by reference.

### TECHNICAL FIELD

This disclosure relates to ergonomic workstations that facilitate healthy motions in performance of duties, such as using a computer, assembling parts or operating equipment. More specifically, it relates to combinations of sensors, software, electronics, and furniture that promote health human motions, especially those performed over extended periods of time.

### BACKGROUND

There are numerous workstation devices that provide ergonomic improvement over conventional computer furniture in the performance of repetitive, long-duration activity. Most focus on improving static positions or are designed to minimize damage of conventional designs. However, optimal usage can never be obtained by any static position.

There are computer stations that allow an operator to exercise while typing at a computer. But these exercises are non-specific to the user and have limited variability—such as trying to duplicate the motion of a treadmill, elliptical exerciser, stair stepper, and stationary bike while typing at a keyboard.

There is a computer desk that incorporates monitoring of physical activity and prompting of the user to undertake physical activity. But the monitoring is relatively simple, focusing primarily on the duration and level of sedentary activity, and then prompting the user to engage in physical activity. It does not consider the adverse effects of chronic loading and static positions resulting in joint and soft tissue derangement relative to what is currently understood in the biophysical sciences; nor does it offer much flexibility in the type of activity allowed.

There are chairs that have powered tilting seat bottom; but there is no user-specific control over the timing, extent, and duration of motion.

### SUMMARY

In one aspect, the present disclosure may relate to a method of improving the health of a user of a workstation. The method entails: collecting biosensor data including duration of an activity, an extent of an activity, an intensity of an activity, and physiological state, or any combination thereof; collecting chair component data associated with the interface between the user and the workstation, including position, strain, acceleration and pressure or any combination thereof; collecting desk array remote sensor data associated with the interface between the user and the workstation including user posture, user position, user acceleration, user gestures, and use voice or any combination thereof; collecting environment data associated with ambient conditions at the workstation including vibration, noise, brightness, glare, air quality, and air temperature or any combination thereof; and maintaining a unique user profile including health history, injuries, fitness goals, physical limitations, and user preferences, or any combination thereof; calculating user-specific motions routines based biosensor data, chair component data, desk array remote sensor data, environmental data, and user profile or any combination thereof; adjusting at least one or more chair components in accordance with user-specific powered or manual motion routines.

In another aspect, the present disclosure may relate to a method of improving the health of a user of a workstation. The method entails: the use of a processing and control unit using at least sensor data, biomechanical and physiological models, and user input to calculate physiological values, comprising of location, movement, acceleration, rotation, stress and strain loading of the spine, head, upper and lower extremities, pelvis and hips, average increases of muscle length, buildup of interstitial toxins, musculoskeletal shortening, musculoskeletal derangement, loss of joint proprioception (positional sense), mental fatigue, mood, and alertness level or any combination thereof; predicting risk factors for loss of endurance, tissue stiffness, decreases in strength, musculoskeletal pain, headaches, reduced ranges of motion, numbness, tingling in the extremities, loss of focus, loss of concentration, reduced productivity; to adjust at the workstation motion routines, the input to the user, or any combination thereof in accordance with these calculations.

In another aspect, the present disclosure may relate to a method of improving the health of a user of a workstation comprising: collecting user workstation data over the Internet, the workstation data including at least one of user profiles, sensor data histories, exercise histories, exercise regimes, and user defined gestures or any combination thereof; collecting user feedback and comment, the user feedback and comment including at least one of responses to workstation-generated feedback, self-initiated feedback, user responses to group comments, user experiences while using a workstation or any combination thereof; storing user workstation data and user feedback on a server; making user workstation data and user feedback, or some part thereof, available to user group members; providing user forums and group discussions for use by members of a user group to record user behaviors and allowing and facilitating group development of at least one of user routines, gesture sets, user-to-user positive feedback, user feedback or any combination thereof; updating user profiles based on group feedback; updating user motion routines in accordance with group input, the group input comprised of a least one of gesture sets, exercise regimens, powered or manual motion routines, user-to-user positive feedback and workstation feedback or any combination thereof; storing, updating, and downloading individual user profiles to allow a single user to operate on multiple workstations without compromising user profiles.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows the entire workstation. FIG. 1.a is an isometric view of the all the components; the seat assembly 70 shown in the ‘user seated’ position. FIG. 1.b is a rear view of the desk tray 120.

FIG. 2 is a side view of the arm assembly 30.

FIG. 3 is a front view of the keyboard tray 34, show in its foldout configuration that holds a full-sized QWERTY keyboard.

FIG. 4 is a top-down view of the keyboard tray 34, show in its foldout configuration that holds a full-sized QWERTY keyboard.

FIG. 5 is a schematic view of the environmental sensor assembly 110.

FIG. 6 is a schematic view of the biosensor group 40.

FIG. 7 is a diagram of the user network 9 that is composed of multiple workstations 500 connected to the corporate server 8.

FIG. 8 is a flowchart covering the main processes associated with this disclosure.

### DETAILED DESCRIPTION

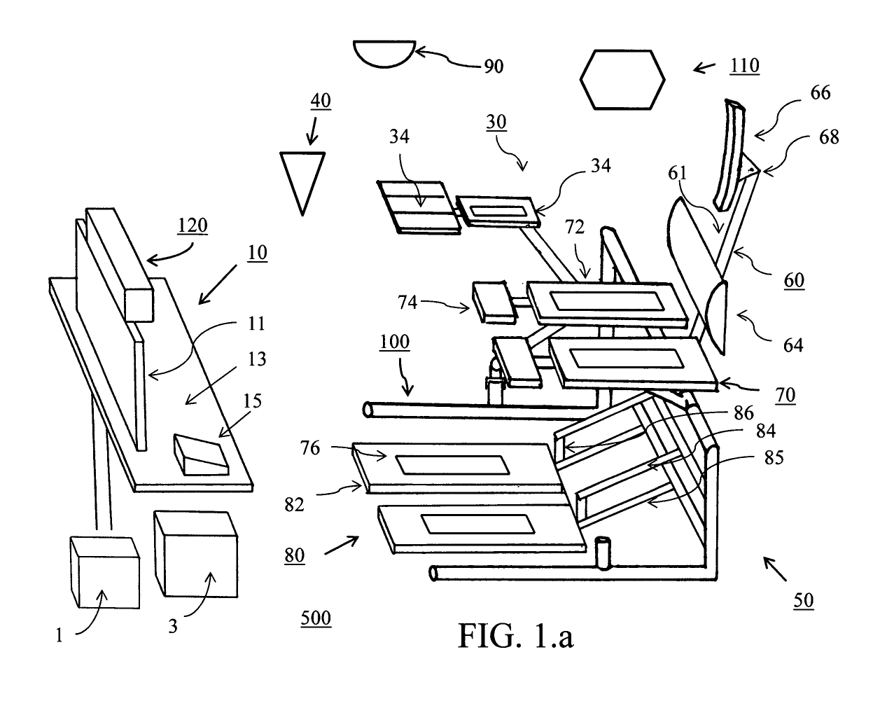

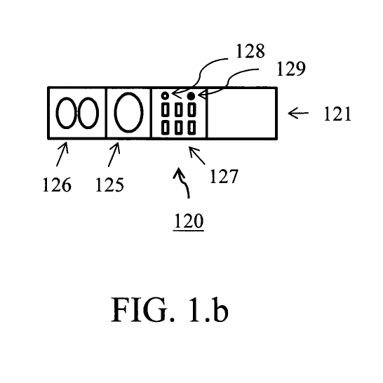

FIG. 1.a is a side view of a workstation that represents an embodiment of the invention. The workstation is composed of a chair 50, an environmental sensor assembly 110, an overhead camera 90, a biosensor group 40, a forward desk 10, a processing and control unit 1, and a computer 3.

The workstation chair 50 is comprised of: a seat assembly 70, two foot assemblies 80, a chair back assembly 60, a support frame 200 and two arm assemblies 30 (only one is shown).

The seat assembly 70 has: two primary seats 72 (one for each thigh); two adjustable forward seat extensions 74 (to accommodate user thigh length), two pressure grids 76 and a support frame 82 (that attaches to all the seat assembly sub-components). The primary seats 72 can elevate, tilt, or move forward and back in opposition to each other. The seat assembly 70 can rotate as a unit, to change the angle between the seat assembly 70 and chair back 60 assembly. The primary seats 72, chair back assembly 60, and the foot pads 82 have pressure grids which communicate the user's contact pressure patterns to processing and control unit 1.

The chair back assembly 60 is composed of a back rest support post 62, a thoracic pad 66 and a lumbar pad 68. The lumbar pad 66 is powered to provide fore and aft motion. The processing and control unit 1 controls the frequency, extent, and duration of the lumbar pad 66 motion. The thoracic pad 66 is intentionally narrow and freely pivots around a horizontal axis.

Each powered foot assembly 80 is composed of a foot pad 82, an upper arm 84, a lower arm 85, and a vertical bracket 86. These components provide for an up and down motion of foot pads 82 while maintaining a horizontal orientation.

The support frame 100 has numerous joints to allow the chair back assembly 60 to lean forward; the seat assembly to tilt; the arm assembly 30 joints allow the arm rest to move in all three cardinal linear and rotational motions; and the foot pads 80 to independently tilt and raise. Each joint in the support frame 100 is powered to provide movement of all the components and has sensors that provide both positional and strain data to the processing and control unit 1.

The support frame 100 also permits the seat assembly 70 to be rotated up and away from the foot pads 82 to provide open space for the user to stand.

The forward work station 10 is comprised of: a height-adjustable table top 13, a main monitor array 11, a feedback monitor 12, a stereoscopic camera 14, an IR camera 125, an ultrasonic sensor array 17 and other appropriate mechanisms for measuring human physiology and health status.

Data from the pressure grids 76, and joint positional 104 and strain 105 sensors in the workstation 200, keyboard tray sensor 122, camera, IR camera 125, stereoscopic camera 126, ultrasonic array 127, wristband 42, headband 44, and finger meter 46 is fed to the processing and control unit 1. The pressure grids 76 provide area pressure data from the user's legs, back, arms, and feet. Pressure grid 76 data can also be used to control devices; for example, pressure girds 76 on the foot pads 82 can be used to measure foot movements which can be translated into mouse clicks. Data from the biosensors 40, stereoscopic camera 16, overhead camera 90, and ultrasonic array 17 are fed to the processing and control unit 1.

Data can be fed into the processing and control unit 1 from personal electronic monitoring devices such as pedometers and smart phones.

User feedback is fed into the central processing and control unit 1 via the keyboard 33, mouse 31, cameras 90, 125, 126, microphone 129, and ultrasonic array 127.

FIG. 1.b is a rear view of the desk tray 120. The desk tray 120 has a stereoscopic still and video camera 126, an IR camera 125, an ultrasonic array 127, a speaker 128, a microphone 129, and a feedback monitor 121.

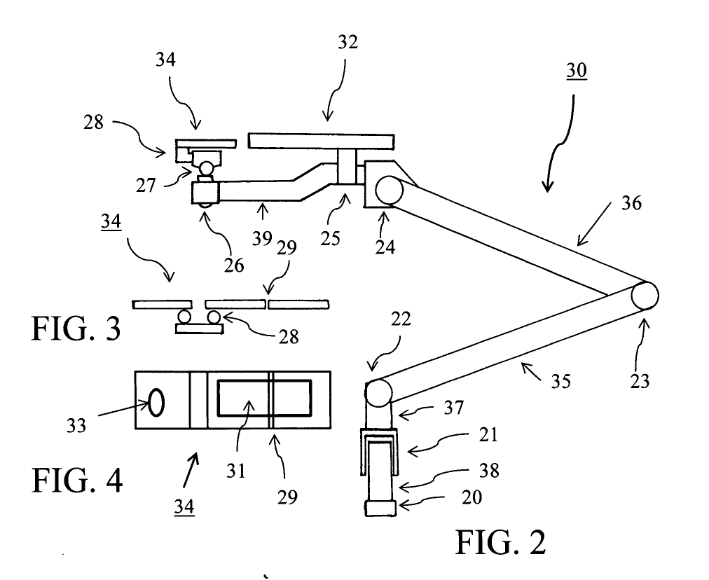

FIG. 2 is a side view of the arm assembly 30. Joints 22-24 permit vertical positioning of the keyboard and forearm rest support arm 39. Joint 24 allows the keyboard and forearm rest support army 39 to tilt. Joint 21 allows the keyboard and forearm rest support arm 39 to angle away from the seat assembly 70 (shown in FIG. 1). Joint 20 allows the forearm rest support arm 39 to swing away from the seat assembly 70 (shown in FIG. 1), as might be done when the user exits the seat.

Joints 26-28 provide for optimal positing of the keyboard tray 34 relative to the user' forearm rest 32. Joint 29 provides for folding of a portion of the keyboard tray 23; this allows the mounting of either a split keyboard, or a standard QWERTY keyboard on just one side.

The keyboard tray 34 can extend from the arm rest to accommodate user forearm length. Joints 27 & 27 allow the keyboard tray 34 to rotate in two planes, which allows wrist pronation/supination and palmar flexion. The keyboard is split into right and left halves so hands can be separated to accommodate a neutral humeral rotation. All army assembly 30 joints are powered to provide cyclic motion. The forearm pressure grid 36 detects downward force on the armrest and pressure distribution pattern.

FIG. 3 is a front view of keyboard tray 34 and its mount to the armrest 32. Joints 28 allow independent rotation of both halves of the keyboard tray 34.

FIG. 4 is a top down view of the keyboard tray 34 showing the foldable split keyboard tray 34 and its associated joint 29. It also shows the keyboard 31, and mouse 33. Fasteners can be used to allow articulation without the input devices falling off of the keyboard tray 34. The mouse 33 can be augmented or replaced with a touch screen. Another camera and additional feedback monitor array can be added to accommodate users that normally look at the keyboard while they type. This allows the user to see what keys they are typing without the user having to look at his hands.

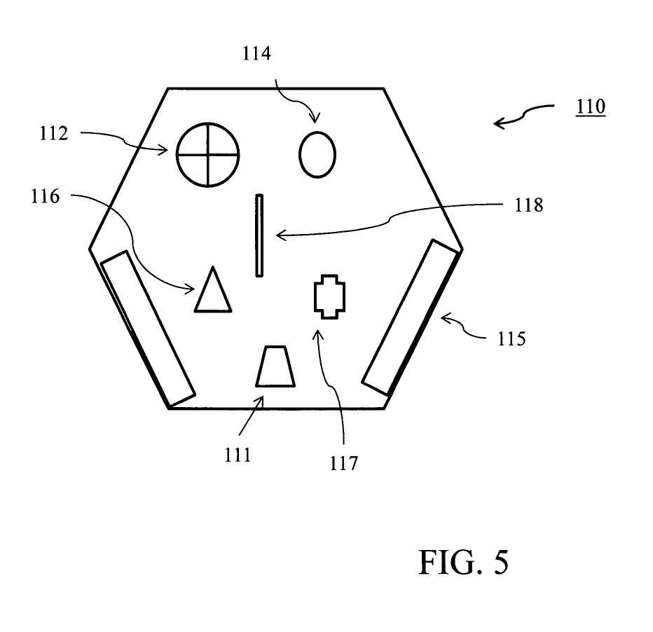

FIG. 5 shows the environmental assembly 110 that includes a noise meter 114, vibration meter 112, thermometer 118, light sensor 117, and air quality meter 116 that provide data to the processing station to monitor factors that impact the user's performance. The environmental assembly 110 also contains a scent emitter 111 and multi-colored lights 115.

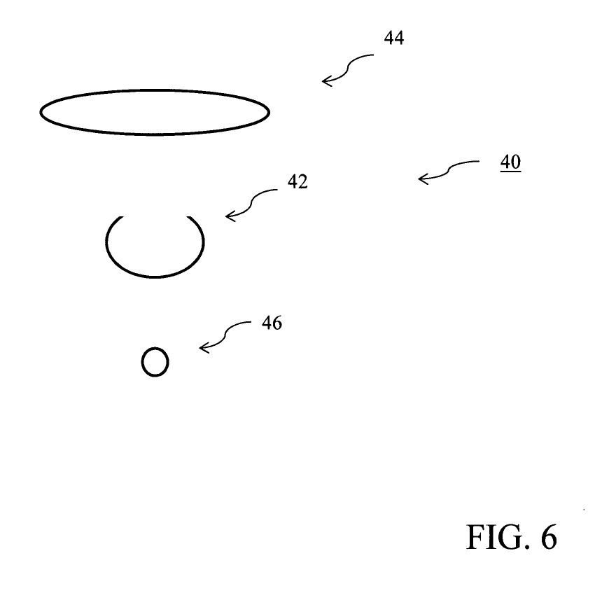

FIG. 6 is a diagram of the biosensor group 40, including a headband biosensor 44, a wristband biosensor 42, and a finger bio meter 46.

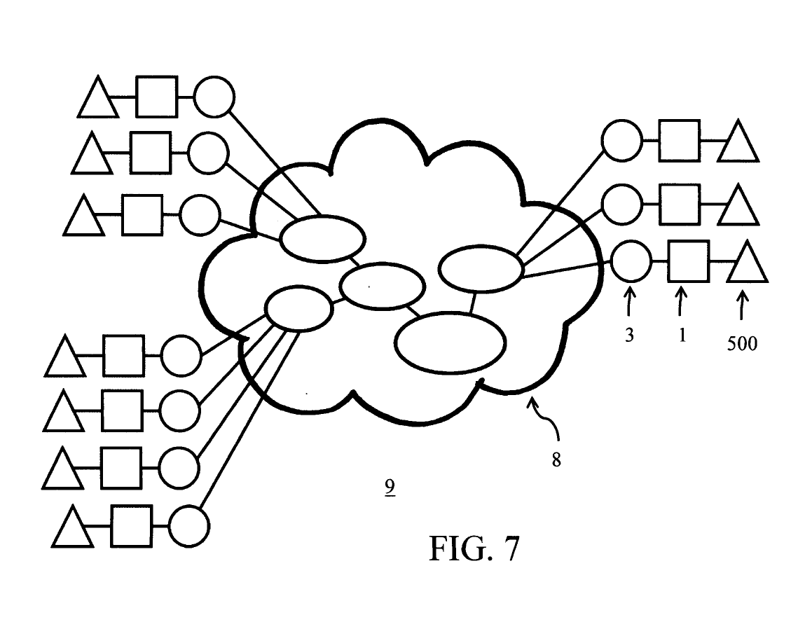

FIG. 7 is a diagram of the user network 9 that is composed of multiple workstations 500 connected to the corporate server 8. The user network 9 directly connects the corporate servers 8 to the user's computer 1 via the interne. The user's computer is hard wired to the workstation processing and control unit 1, which controls various parts of the workstation 500, including speaker 128 (FIG. 1.b), feedback monitor 121 (FIG. 1.b), multi-colored lights 115 (FIG. 5), scent emitter 111 (FIG. 5). The processing and control unit 1 also updates the user profile based on input received via the intranet from other users and the corporate server.

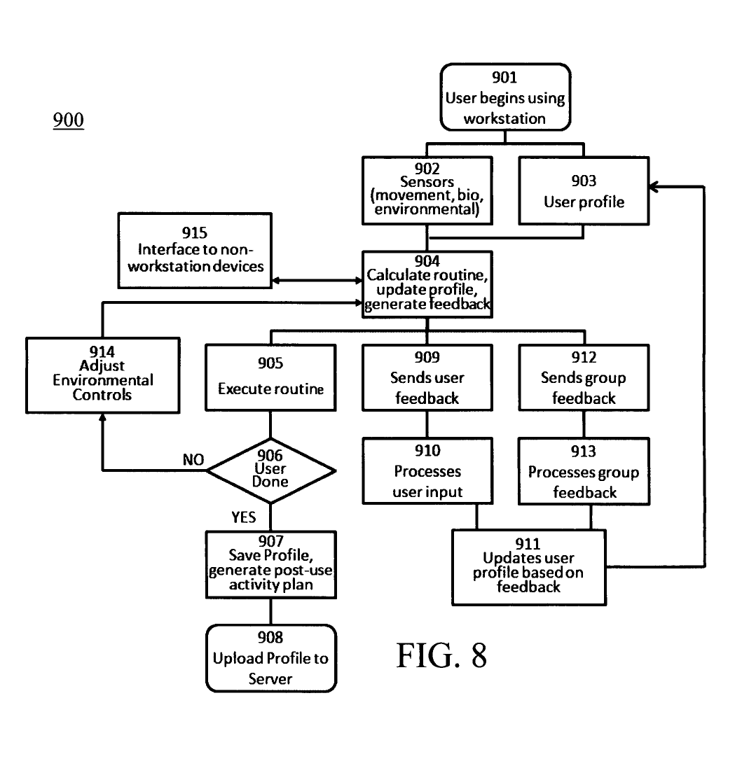

FIG. 8 depicts a flowchart for how the various system components interact.

### INDUSTRIAL APPLICABILITY

FIG. 1.a illustrates all the components of a standalone workstation 500. The workstation chair 50, allows the user's arms, legs, spine, and pelvis to go through a dynamic range of motion about a neutral central position. As shown, the workstation depicts a configuration tailored for a computer user; however appropriate components could be adapted to other work environments. For example truck drivers could benefit primarily from the chair 50; assemblers could benefit from virtually all the components except for the keyboard tray 34—which might be replaced by an assembly sub-station.

All powered components of the chair 50 can be controlled by the central processing unit 1 to cycle the user's body through healthful motions, to expose the user to vibrations, and to provide mechanical muscle therapy while working.

The seat assembly 70 allows for anterior and posterior pelvic tilt, lateral pelvic tilt, pelvis-to-lumbar counter rotation, sacral torsion and sacral flexion. Each primary seat 72 includes a forward seat extension 74 that is adjustable to accommodate varying lengths of the user's thigh; and a pressure grid 76 to measure contact pressure and distribution between the primary seat 72 and the user's pelvis and thigh. Based on pressure grid data 76, the central processing unit can alter the angle and position of each primary seat 72 to reduce areas of high pressure.

The chair back assembly 60 is composed of a chair back support post 61, a lumbar pad 64, a thoracic pad 64, and a thoracic pad pivot joint 68. The lumbar pad 64 is powered to provide fore and aft motion to effect a variable degree of lumbar spine curvature and support. The central processing unit 1 controls the frequency, duration, and degree of excursion of the lumbar pad to minimize tissue derangement. The thoracic pad 66 is intentionally narrow to allow freedom of motion of the user's scapulae, and it freely pivots around a horizontal axis to accommodate the user's specific body shape, and changes in spinal position and alignment due to positioning of the powered lumbar pad 64. In conventional office furniture, the chair back is wide, inhibiting freedom of humeral and scapulae rotation, thereby constraining the user to limited seating positions.

Each foot assembly 80 is composed of a foot pad 82, a variable-length upper arm 84, a lower arm 85, and a vertical bracket 86. The assembly is powered so that the processing station can independently control foot height and tilt—allowing for cyclic foot motion while sitting, or stair-stepper motion while standing. The foot pads 82 can be cycled slowly to prevent the user from being in the same static position for excessive periods of time, or they can be cycled more rapidly to permit exercise.

The arm assemblies 30 can rise to accommodate user elbow height. As a unit, the arm assembly 30 moves fore and aft; rotates internally; and tilts medially. The arm rest 32 allows the user's arm to move through ranges of flexion, extension, abduction, adduction, internal/external rotation. The keyboard tray 34 articulates independent of the arm rest 32 to permit the user's wrists to move in inflection, extension, supination and pronation.

The forward desk 10 can be controlled by the central processing unit 1 to adjust vertical height, and provide user feedback via the feedback monitor 121 and the speaker 128.

FIG. 1.b illustrates the desk array 120 which houses various sensors directed at the user. Data from these sensors, in combination with data from the overhead camera 90, is fed into the central processing unit 1 to determine the user's posture and position and to recognize gestures.

FIG. 5 shows the environmental assembly 110 which is used to measure the environment around the workstation, and provides aromas and supplemental lighting. Data from the environmental sensors is fed to the central processing unit 1 to modify powered or manual motion routines, to modify the work environment, or to provide feedback to the user. As an example, when the user is participating in an exercise routine, such as stair stepping activity, the central processing unit 1 can lower the room temperature.

FIG. 6 depicts the biosensor group which includes a wristband biosensor 42, headband biosensor 44, and finger meter 46. Data from these sensors is fed to the central processing unit 1 to determine user physiology and make adjustments to the motion routine or environment. For example, when the central processor unit receives data from the headband biosensor 44 indicating that the user is becoming sleepy, the central processor unit 1 can adjust the motion routine to begin exercise and raise the light level.

All the sensors can input data to the central processing unit 1 through several means, including but not limited to, hardwire, wireless, or Bluetooth. Non-workstation sensors and devices can similarly be connected to the central processing unit 1. For example, on an assembly line a motion sensor can be connected to various hand tools used in the assembly process to monitor usage that might result in repetitive motion injuries. Or the central processing unit 1 can cycle the user's location with respect to assembly stations to assure that the user's shoulders do not remain in a stationary configuration for long durations.

FIG. 7 depicts multiple workstations 500 interconnected via the interne or intranet. This enables individual user sensor data and profiles to be fed to either the Oasis Be Well server 8 or the user's corporate server. This allows a single user to work at one or more workstations 500 each of which having access to the user's profile and usage history. User groups can also be formed to provide a social component of workstation usage. Group members can share their progress towards health gains, gesture sets, movement routines, user experiences, and other factors that improve employee performance and enjoyment. User data can also be scored by the corporate server to provide users with individual report cards on their progress, or to provide group statistics that can be used by management to track employee health and benefit. User groups can also be comprised of users having similar goals, characteristics, or challenges. For example, a user group of people suffering from arthritis in their hips might develop unique gestures and or routines that minimize weight bearing. Conversely, a different user group composed of runners can develop powered or manual motion routines that involve more weight bearing postures and time spent in exercise. Users can monitor each other's usage and successes in meting personal fitness goals, encourage each other towards achieving healthful habits, or collectively design workstation improvements.

The central processing unit 1 allows users to build and maintain their own profiles. A user profile can include health history, health limitations, personal health goals, history of their interactions with the workstation 500, and user defined gesture sets. The user profile would be used by the processing and control unit 1 to: manage in-use user posture and activity, generate in-use notifications, and generate post-use exercise plans. Specific profiles of activity can be programmed for a particular user based on impairments or health challenges in order to reduce impairment. For example, if a user suffers from frozen shoulder syndrome, the processor might apply a specific range-of-motion protocol designed to cycle the affected shoulder through an ever-increasing range of motion—to restore normal movement. Each user of the system would have their own profile; and a single user could utilize their profile at multiple workstations by downloading their profile from one workstation and transferring it to a different workstation. Over time, the user profile can be updated by the central processing unit 1 to reflect gains in physical capacity, user feedback, user gesture sets, or user group feedback.

Referring to FIGS. 1-8, a method, purpose, and benefit of using the workstation 500 will be discussed. The user initiates activity on the workstation 500, step 901. The user uniquely identifies him or herself to the central processing unit 1 using the keyboard 31, gestures, mouse 33, voice, or a combination thereof. The central processing unit 1 then references the user profile, step 903, and begins receiving input from all the workstation sensors, step 902; and then calculates a motion routine to move the user through healthful motions and postures or prompt the user through manual changes in healthful motions and posture while the user is engaged with the workstation, step 904. This routine is executed by the various powered components of the workstation, step 905, including the chair, desk, speaker and environmental devices. The intended outcome is to allow the user to efficiently perform required tasks while mitigating damaging health effects associated with the traditional workstation; depending on the task at hand, the user may even realized health gains while working. For example, a student on the tennis team may gain should flexibility while doing homework.

The processing and control unit 1 develops and selects appropriate manual or powered workstation routines, step 904, which are motions that are used to provide either: timed shifts in location and angle to change the user position in timed steps; cyclic or quasi-cyclic continual motion about a neutral user position to eliminate static postures; or to engage the user in low-level exercise.

The central processing unit 1 is initially programmed with numerous static posture and powered or manual motion routines and gestures that are derived from research data, including, but not limited to anthropometric, biomechanical, cardiovascular, physiologic, and orthopedic models. These routines are intended to minimize or reverse the acute or chronic health challenges typically associated with users of the traditional workstations, such as carpal tunnel syndrome, headaches, neck and back pain and stiffness, tendonitis, and numbness. Numerous studies demonstrate these injuries cost businesses billions of dollars of additional health care costs annually. Studies also demonstrate the benefit of removing workers from workplace environments where they maintain stationary postures and perform repetitive motions.

The support frame 100 also permits the seat assembly 70 to be rotated up and away from the foot pads 82 to provide open space enabling the user to function from a standing position while maintaining both a consistent distance between the user's eyes and monitor array 11, and the user's torso and armrest 32 and keyboard tray 34. In the standing configuration, the processing station can activate the foot pads 82 to facilitate either manual or powered exercise. In the current configuration, the exercise would be similar to a stair stepper; however modifications could allow the user's feet to move elliptically, and since the armrest 32 can also be powered fore and aft, the user would effectively be on an elliptical exerciser. Another configuration would have the user's feet moving fore and aft, effectively simulating a cross-country skier. In another configuration the central processing unit 1 and accommodate input and send control to a variety of exercise equipment that may be desired by the user, such as a tread mill, elliptical exerciser, or stationary bicycle in addition to or in place of the foot pads 82.

Biosensors 40 are used to measure user physiological factors to determine a physiological state and can make adjustments to a routine. A wristband 42 can be used to measure blood pressure, heart rate, and blood glucose level. A headband 44 can measure brain wave activity. A finger meter 46 can measure blood oxygen level. The central processing unit 1 can accommodate input from additional sensors as new technology develops, and calculate improvement to user routines.

While the user is in the workstation 500 data from all sensors provides real-time information to the central processing unit 1. Data from the pressure grids 76, and joint positional 104 and strain 105 sensors in the workstation 200, keyboard tray sensor 122, camera, IR camera 125, stereoscopic camera 126, ultrasonic array 127, wristband biosensor 42, headband biosensor 44, and finger meter 46 is used by the processing and control unit 1 to infer: duration and extend of user activity and user position; movement, and gesture; and user's physiological state. The pressure grids 76 provide area pressure data from the user's legs, back, arms, and feet; this data is used by the processing station to infer user activity, which is used to estimate strain on user joints, buildup of toxins in tissues, and repetitive motion statistics. Pressure grid 76 data can also be used to control devices; for example, pressure girds 76 on the foot pads 82 can be used to measure foot movements which can be translated into mouse clicks. The stereoscopic camera 16, overhead camera 90, and ultrasonic array 17 provide data to the processing and control unit 1 that is used to infer user movement, gestures or level of fatigue. The biosensors 40 provide data on user heart rate, respiration, blood chemistry and brain wave activity.

The processing and control unit 1 receive data from personal electronic monitoring devices, step 915, like pedometers and smart phones, and can update and improve workstation routines, step 904, based on user activities engaged in even when they are not at the workstation. For example, if the user has just finished a workout and the gym, the processing and control unit 1 would calculate a reduced-motion routine. It further incorporates information about user communications, like email, to calculate effects on user mood, and to update the workstation routines. For example, a sentiment analysis of the user's incoming email provides a measure of the outside stresses being placed on the user. Physiological monitoring of user behavior can be used to determine user mood and general mental state. Based on this in-use, or pre-use data, the central processing unit 1 can update and adjust the routine, step 905.

The processing and control unit 1 also receives real-time input from the environmental sensors and can adjust environmental factors as needed to assure optimal comfort and performance of the user, step 914.

The powered workstation components can move to provide clear egress when the user exits the workstation 500, step 906; the central processing unit updates the user's profile, creates a post-use activity plan, 917, and uploads the new profile to the central processing unit 1, corporate server or the Oasis Be Well server, step 908.

During operation, the central processing unit 1 provides real-time feedback to the use, step 909 based on user-selected parameters such as heart rate or temperature. The central processing unit 1 can also provide instructions or queries to the user, such as “Would you like to begin exercising?” Spoken or displayed feedback could be used to describe optimal corrective behaviors. Dials and gauges could be used to display overall or cumulative damage; or to countdown to next recommend break or exercise session.

The user can then respond to the feedback or queries supplied by the central processing unit 1 via keyboard, mouse, microphone or gestures. Based on this user response, the central processing unit 1 can update routines, step 910, and user profile, step 911. For example, if the user responds positively with his voice, the central processing unit 1 can initiate exercise and update user profile to indicate a willingness to exercise based on the voice signal that had been processed with voice recognition software. The exercise could either be powered, or accomplished by the user only.

Data from sensors in the desk array 120, allow the processing and control unit 1 to determine user activity and posture, and to track and interpret user gestures that would normally come from the keyboard or mouse. This reduces the number of keystrokes and mouse movements needed by the user. These optimized gestures minimize or reverse the adverse health effects typically experienced by users relying on traditional mouse and keyboard technologies.

Users can either use predefined gestures or define their own new gestures. A unique element of the workstation 500 is that users can develop and evaluate new gestures according to bio-mechanical models that are part of the central processing unit's 1 algorithms. In this scenario, the user signals to the central processing unit 1 that a new gesture is being defined. The central processing unit 1 records the new gesture using the various workstation sensors, and then evaluates and scores the quality of the gesture against known healthful movements. The use can then use this score to determine if he wants to add the new gesture to his user profile. If the user wants to keep the gesture, he can define that actions associated with the gesture—which can be to control the computer 3, workstation 500, or even non-workstation devices. For example, the user could define gestures that engage the overhead camera 90 to digitize documents that are placed on the table top 13. Additional gestures can be defined to select only portions of the page to be digitized; follow-on gestures can be defined to move the newly-digitized text into other documents. Finally, these new gestures could be shared with other members of their user groups.

The processing and control unit 1 can also be used to control non-workstation devices, step 915, through standard interface connections. For example, a user can define a gesture for answering a phone via Bluetooth connection, or to activate a height adjustable desk via USB connection. In an industrial workplace environment, a user may create a gesture to advance an assembly piece on an assembly line, so that the user would not have to leave the workstation 500 to perform their duties. Or if the user declines a central processing unit 1 initiated suggestion to exercise while in the workstation, the central processing unit 1 can schedule a time for exercise for after work on their smartphone.

The body-part positional sensors 120 allow gesture recognition by the processing and control unit 1 to provide a user input that could be used to replace signals normally provided by the standard keyboard, mouse interface. The implementation of gesture recognition provides an additional capability where the processing station provides direct input to the computer, supplementing the traditional input from keyboard and mouse.

The system incorporates user feedback in the development of additional workstation routines. The user can input feedback to processing and control unit 1 via keyboard 31, mouse 33, microphone 129 or gestures which are used to update or change the current workstation routine, step 904. For example, if during a workstation routine the users begin experiencing pain in their left shoulder, the user can signal the processing and control unit 1, upon which the processor would reduce the extent of motion of the left arm assembly.

The extent and duration of user activity, in combination with the biosensor 40 data can be used to determine risk factors for headache, fatigue, joint or connective tissue injury. In combination with the user history (e.g. previous injuries; changes in weight or fitness level; personal goals) these factors are used by the processing and control unit 1 to provide feedback to the user, either during activity through the feedback monitor 12 or feedback speaker 18; or after the user has finished an extended period of performance (by generating either a printout or email). Users can be alerted to corrective behaviors (e.g. to sit up straight), or encouraged to take a break. Tailored recommendations can be also given. For example, after completing a long drive, a truck driver may be prompted with recommendations for specific exercises to correct for any strain or injury incurred during the drive.

The traditional position of having the keyboard directly in front of the user is not consistent with neutral operator position. The workstation 500 can be specifically configured for computer users by allowing the user to keep their arms and hands in a near-neutral position This can be accomplished by splitting a conventional QWERTY keyboard, thus allowing the arms and hands to assume positions that are near neutral, and that can be dynamically changed over time. Other options can provide one-handed keyboards so that that other hand can operate provide mouse or joystick. The keyboard can be replaced with a touch screen or gesture sensor to allow finger swipes to input words (similar to tools used with cell phones). Since many computer users rely on being able to see the keyboard while typing, a camera/monitor configuration can be used to allow users to see their hands without looking down.

Another aspect includes standard connections, work spaces and storage compartments to allow the user to perform their entire function without dismounting the workstation. Examples would include phone jacks, 110-v outlets, or USB ports. Devices would include a phone, printer, camera or scanner. Storage would be provided for assembly parts or office supplies. Depending on how often the user had to use a device or storage compartment, they would either be located within easy reach or could be articulated and cycled to facilitate optimal user motions.

What is claimed is:

1. A method of improving the health of a user of a workstation, the method comprising:
collecting biosensor data associated with the interface between the user and the workstation, the biosensor data including at least one of a duration of an activity, an extent of an activity, an intensity of an activity, and physiological state or any combination thereof;
collecting chair component data associated with the interface between the user and the workstation, the component data a including at least one of position, strain, acceleration and pressure or any combination thereof;
collecting desk array remote sensor data associated with the interface between the user and the workstation, the desk array data including at least one user posture, user position, user acceleration, user gestures, and use voice or any combination thereof;
collecting environment data associated with ambient conditions at the workstation, the environmental data including at least one of vibration, noise, brightness, glare, air quality, and air temperature or any combination thereof;
maintaining a unique user profile, the profile including at least one of health history, injuries, fitness goals, physical limitations, or any combination thereof;
calculating user-specific motion routines based on at least one of biosensor data, chair component data, desk array remote sensor data, environmental data, and user profile or any combination thereof;
adjusting at least one or more chair components in accordance with user-specific motion routines.

2. The method of claim 1 wherein biosensor monitoring includes at least one of a heart rate monitor; wristband biosensor, headband biosensor, and finger meter or any combination thereof.

3. The method of claim 1 wherein chair component monitoring includes using at least one of joint stress sensors; joint position sensors; accelerometer; pressure grids; joystick, keyboard and mouse activity sensors or any combination thereof.

4. The method of claim 1 wherein environmental monitoring includes using at least on of a vibration sensor; noise sensor; air quality sensor; thermometer; and light sensors or any combination thereof.

5. The method of claim 1 wherein desk array remote sensor monitoring includes using at least one of a stereoscopic still and video camera; IR camera; microphone; ultrasonic array; or any combination thereof;

6. The method of claim 1 wherein user motions are affected by moving at least one the arm assembly, seat, seat back, foot platforms, forward workstation, user gestures or any combination thereof.

7. The system of claim 1 wherein adjustment are made to the ambient conditions at the workstation based up the environmental data, including at least one of temperature, aromas, light level, hue, sound, music and any combination thereof;

8. A method of improving the health of a user of a workstation, the method comprising:
utilizing a processing and control unit that relies on at least one of sensor data, user data, user profile, or any combination thereof;
utilizing a processing and control unit with at least one of biomechanical algorithms, physiological algorithms, anthropometric algorithms, or any combination therein;
utilizing a processing and control unit to calculate at least one of physiological values, the physiological values comprised of at least one of location, movement, acceleration, rotation, stress and strain loading of the spine, head, upper and lower extremities, pelvis and hips; average increases of muscle length; buildup of interstitial toxins; musculoskeletal shortening or derangement; loss of joint proprioception; positional sense; mental fatigue; mood; and alertness level or any combination thereof;
utilizing a processing and control unit to predict risk factors for loss of endurance; tissue stiffness; decreases in strength; musculoskeletal pain; headaches; reduced ranges of motion; numbness and tingling in the extremities; loss of focus or concentration; reduced productivity; and
adjusting at least one of the workstation motion routines, the input to the user, or any combination thereof in accordance with these calculations;
prompting the user to initiate self-powered, user-specific motion routines.
